(19) United States
(12) Patent Application Publication
(10) Pub. No.: US 2009/0181682 A1
(43) Pub. Date: Jul. 16, 2009

(54) CELLULAR COMMUNICATION SYSTEM AND A METHOD OF SIGNALLING THEREFOR

(75) Inventor: Stephen John Barrett, Berkshire (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/297,096

(22) PCT Filed: Mar. 19, 2007
(86) PCT No.: PCT/US07/64282

§ 371 Date: Oct. 14, 2008

(30) Foreign Application Priority Data
Apr. 21, 2006 (GB) 0607886.9

(51) Int. Cl. H04W 36/00; H04W 72/04

(52) U.S. Cl. 455/442; 455/450

(57) ABSTRACT

A cellular communication system comprises base stations which support soft handover communication of uplink data from a remote station 101. A first base station 105 comprises a scheduler 203 which schedules the uplink data from the remote station. An uplink rate controller 209 sets an uplink data rate for the remote station. A schedule processor 205 determines a future scheduling resource allocation for the remote station and an uplink rate selector 207 selects the uplink data rate to indicate the future scheduling resource allocation. A second base station 113 comprises an uplink rate processor 303 which detects the uplink data rate from the remote station. A resource estimator 305 estimates a future resource usage for the remote station in the cell of the second base station 113 in response to the uplink data rate. A scheduler 307 in the second base station may schedule data in response to the estimated future resource usage.

### FIELD OF THE INVENTION

The invention relates to a cellular communication system and in particular, but not exclusively, to signalling of uplink scheduling information in a 3^{rd} Generation cellular communication system.

### BACKGROUND OF THE INVENTION

Currently, the most ubiquitous cellular communication system is the 2nd generation communication system known as the Global System for Mobile communication (GSM). Further description of the GSM TDMA communication system can be found in ‘The GSM System for Mobile Communications’ by Michel Mouly and Marie Bernadette Pautet, Bay Foreign Language Books, 1992, ISBN 2950719007.

3rd generation systems have recently been rolled out in many areas to further enhance the communication services provided to mobile users. One such system is the Universal Mobile Telecommunication System (UMTS), which is currently being deployed. Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876. The core network of UMTS is built on the use of SGSNs and GGSNs thereby providing commonality with GPRS.

Although 3^{rd} Generation systems are currently being rolled out, the standardisation process has continued to develop the systems to provide additional functionality and new services. For example, an efficient method of supporting downlink packet data known as the High Speed Downlink Packet Access (HSDPA) service has been defined. Currently, standardisation efforts include the definition of a High Speed Uplink Packet Access service (HSUPA) for efficiently supporting packet data communication in the uplink direction.

HSDPA and HSUPA use a number of similar techniques including incremental redundancy and adaptive transmit format adaptation. In particular, HSDPA and HSUPA provide for modulation formats and code rates to be modified in response to dynamic variations in the radio environment. Furthermore, HSDPA and HSUPA use a retransmission scheme known as Hybrid Automatic Repeat reQuest (H-ARQ). In the H-ARQ scheme incremental redundancy is provided by a use of soft combining of data from the original transmission and any retransmissions of a data packet.

In HSDPA and HSUPA, transmission code resources are shared amongst users according to their traffic needs. The base station or “Node-B” is responsible for allocating and distributing the resources to the users, within a so-called scheduling task. Hence, for HSDPA and HSUPA, some scheduling is performed by the RNC whereas other scheduling is performed by the base station. Specifically, in HSUPA the base station can make use of whatever noise rise resource is unused by the RNC. No explicit signalling is required, though the RNC does indicate the maximum noise rise usable by both HSUPA and other channels (e.g. DCH channels) summed together). The base stations independently schedule transmissions to or from the mobile stations that are attached to it, operate a retransmission scheme, control the coding and modulation for transmissions to and from the mobile stations and transmits (for HSDPA) and receive (for HSUPA) data packets from the mobile units.

Thus, for HSUPA each mobile station has a serving base station which comprises an HSUPA scheduler that schedules the uplink data transmitted from the mobile station on an HSUPA uplink channel known as the E-DCH (Enhanced-Dedicated CHannel).

HSUPA supports soft handover on the uplink E-DCH channel whereby the signal transmitted from the mobile station can be received by a plurality of base stations and combined to improve the reliability of reception (soft combining is used for cells of a single base station whereas selection combining is used for cells of different base stations). However, as a consequence, some base stations will be receiving signals that are scheduled by other base stations. This will cause interference to other communications and will effectively utilise some of the power resource available for HSUPA communication within that cell. However, as the scheduling is by another base station, the HSUPA scheduler of a base station supporting a soft handover (but not itself being the serving cell) does not have any information of how much resource is used by this communication.

More specifically, the noise rise in cell k is composed of a number of components:

i) Received signals on conventional dedicated channels (DCH signals)
ii) Received signals on access channels (RACH signals)
iii) HSUPA communications (E-DCH signals) scheduled by other cells i≠k.
iv) HSUPA communications (E-DCH signals) scheduled by the cell k.
v) Inter-cell interference from mobile stations which are connected to other cells and which are therefore not decoded in cell k.

The HSUPA scheduler associated with any one cell is responsible for determining how much power it can allocate in the forthcoming scheduling interval (i.e. to determine noise rise attributable to item (iv) above). In order to determine how much noise rise will be available for the scheduling of traffic (determining component (iv)), it must first make predictions of the noise rise that will be attributable to all the other components: i, ii, iii and v in the forthcoming scheduling interval.

For efficient scheduling, it is thus important to predict the amount of power attributable to item (iii): E-DCH received signals (scheduled by other cells i≠k). In typical systems, the amount of uplink E-DCH power received in any given cell (e.g. cell k) from communications scheduled by other non-serving cells can be very significant. For example, if 50% of calls are in one-way handover, 30% of calls are in two-way soft handover and 20% of calls are in three-way soft handover then 40% of links that are decoded in a given cell (and hence ˜40% of E-DCH power) will be attributable to mobile stations for which the E-DCH is scheduled by another cell.

Ideally allocations on the E-DCH would be made for very short intervals (as short as 2 ms) in order to exploit the capacity, throughput and coverage benefits of “upfade riding”. However, if another cell i≠k changes its allocations rapidly then this makes it harder for cell k to predict, in a forth-coming interval, the noise rise that will be consumed by E-DCH's which it does not schedule itself (e.g. which are scheduled by cell i). One way to make the prediction better is by only making allocations that last for a long duration. However it can be seen that there are conflicting requirements, on the one hand to reduce the duration of scheduler allocations (to get upfade riding benefits) and on the other hand to increase the duration of the allocations (to better facilitate prediction).

Hence, an improved system would be advantageous and in particular a system allowing information to be determined for communications scheduled by other cells, improved scheduling, increased flexibility and/or improved performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a cellular communication system comprising: a plurality of base stations for supporting soft handover communication of uplink data from at least a first remote station; a first base station of the plurality of base stations comprising scheduling means for scheduling the uplink data from the first remote station, setting means for setting an uplink data rate for the first remote station, means for determining a future scheduling resource allocation for the first remote station, and means for selecting the uplink data rate to indicate the future scheduling resource allocation; and a second base station of the plurality of base stations comprising: means for detecting the uplink data rate in response to receiving the uplink data from the first remote station, and estimating means for estimating a future resource usage for the first remote station in a cell of the second base station in response to the uplink data rate.

The invention may allow improved performance in a cellular communication system. In particular, the invention may allow implicit signalling of resource allocation information between base stations without requiring any communication directly between the base stations via the fixed network. The invention may allow implicit signalling without requiring modifications of Technical Specifications for many cellular communication systems, and specifically the invention may allow compatibility with for example 3^{rd} Generation cellular communication systems. The invention may allow a base station to estimate future resource usage for services scheduled by other base stations and may thus allow an improved or optimised performance and operation for the specific scheduling applied.

According to an optional feature of the invention, the future scheduling resource allocation is a future scheduling uplink data rate.

This may allow improved performance, efficient implementation and/or compatibility with existing requirements.

According to an optional feature of the invention, the future scheduling resource allocation is a future scheduling uplink power resource.

This may allow improved performance, efficient implementation and/or compatibility with existing requirements.

According to an optional feature of the invention, the future resource usage is a future uplink interference level of the first remote station in the cell of the second base station.

This may allow improved performance, efficient implementation and/or compatibility with existing requirements. The interference level may e.g. be an estimated noise rise increase and/or a measure of interference to other communications in the cell of the second base station.

According to an optional feature of the invention, the second base station further comprises second scheduling means for scheduling uplink data for at least a second remote station supported by the second base station in response to the future resource usage.

The invention may allow improved scheduling in a base station taking into account resource used by scheduling in other base stations without requiring explicit resource information exchange over the fixed network. An improved scheduling resulting in increased capacity and/or Quality of Service (QoS) of the cellular communication system as a whole can be achieved.

According to an optional feature of the invention, the second scheduling means is arranged to modify the scheduling of uplink data for the at least second remote station in response to a detection that a resource usage of the first remote station in the cell of the second base station deviates from the future resource usage.

This may allow an improved and more flexible scheduling.

According to an optional feature of the invention, the first base station is arranged to select uplink data rates for a number of initial time intervals to indicate a future scheduling resource allocation in a future time interval.

This may allow improved performance and/or a facilitated implementation. The number of initial time intervals may be one.

According to an optional feature of the invention, the uplink data rates are selected to form a pattern indicative of the future scheduling resource allocation in the future time interval.

This may allow improved performance and/or a facilitated implementation.

According to an optional feature of the invention, the pattern is a binary pattern of transmission or no transmission in the initial time intervals.

This may allow improved performance and/or a facilitated implementation.

According to an optional feature of the invention, the uplink data rates of the number of initial time intervals are lower than the second uplink data rate.

This may allow improved performance and/or a facilitated implementation. For example, a scheduler may be able to pre-emptively take into account a high resource usage scheduled by another scheduler.

According to an optional feature of the invention, the number of initial time intervals fall within a duration shorter than a retransmission time for a retransmission scheme for the first remote station.

This may allow improved performance and/or a facilitated implementation. In particular, it may prevent that retransmission operation disrupts the implicit signalling between base stations.

According to an optional feature of the invention, the first base station is arranged to restrict uplink data rate changes in accordance with a change criterion and the estimating means is arranged to estimate the future resource usage in response to a detection that the uplink data rate matches the change criterion.

This may allow improved performance and/or a facilitated implementation. For example, if the first scheduler is planning to schedule uplink data rate at a high data rate, the data rate may be gradually increased in accordance with a ramping profile.

According to an optional feature of the invention, the setting means is arranged to communicate an absolute uplink data rate indication to the first remote station.

This may allow improved performance and/or a facilitated implementation in many embodiments.

According to an optional feature of the invention, the setting means is arranged to communicate a relative uplink data rate indication to the first remote station.

This may allow improved performance and/or a facilitated implementation in many embodiments.

According to an optional feature of the invention, the cellular communication system is a 3^{rd} Generation Cellular Communication system.

The invention may allow improved performance and/or a facilitated implementation in a 3^{rd} Generation Cellular Communication system.

According to an optional feature of the invention, the first and second base station are arranged to support a High Speed Uplink Packet Access, HSUPA, service of the first remote station.

The invention may allow improved performance and/or a facilitated implementation for HSUPA services.

According to an optional feature of the invention, the scheduling means is arranged to schedule uplink data for an Enhanced Dedicated CHannel, E-DCH, of the first remote terminal.

The invention may allow improved performance and/or a facilitated implementation for E-DCH communications.

According to another aspect of the invention, there is provided a base station for a cellular communication system, the base station comprising: means for supporting soft handover communication of uplink data from at least a first remote station; scheduling means for scheduling the uplink data from the first remote station; setting means for setting an uplink data rate for the first remote station; means for determining a future scheduling resource allocation for the first remote station; and means for selecting the uplink data rate to indicate the future scheduling resource allocation.

According to another aspect of the invention, there is provided a base station for a cellular communication system, the base station comprising: means for supporting soft handover communication of uplink data from at least a first remote station; means for detecting an uplink data rate in response to receiving the uplink data from the first remote station, the uplink data rate being indicative of a future scheduling resource allocation from a different base station arranged to schedule the uplink data; and estimating means for estimating a future resource usage for the first remote station in a cell of the second base station in response to the uplink data rate.

According to another aspect of the invention, there is provided a method of signalling in a cellular communication system comprising a plurality of base stations supporting soft handover communication of uplink data from at least a first remote station; the method comprising: at a first base station of the plurality of base stations performing the steps of: scheduling the uplink data from the first remote station, setting an uplink data rate for the first remote station, determining a future scheduling resource allocation for the first remote station, and selecting the uplink data rate to indicate the future scheduling resource allocation; and at a second base station of the plurality of base stations performing the steps of: detecting the uplink data rate in response to receiving the uplink data from the first remote station, and estimating a future resource usage for the first remote station in a cell of the second base station in response to the uplink data rate.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a cellular communication system in accordance with some embodiments of the invention;

FIG. 2 illustrates an example of a base station in accordance with some embodiments of the invention;

FIG. 3 illustrates an example of a base station in accordance with some embodiments of the invention;

FIG. 4 illustrates an example of an uplink data rate profile in accordance with some embodiments of the invention; and

FIG. 5 illustrates an example of an uplink data rate profile in accordance with some embodiments of the invention.

### DETAILED DESCRIPTION OF SOME EMBODIMENTS OF THE INVENTION

The following description focuses on embodiments of the invention applicable to a 3^{rd} Generation cellular communication system and in particular to a UMTS cellular communication system supporting an HSUPA service. However, it will be appreciated that the invention is not limited to this application but may be applied to many other cellular communication systems.

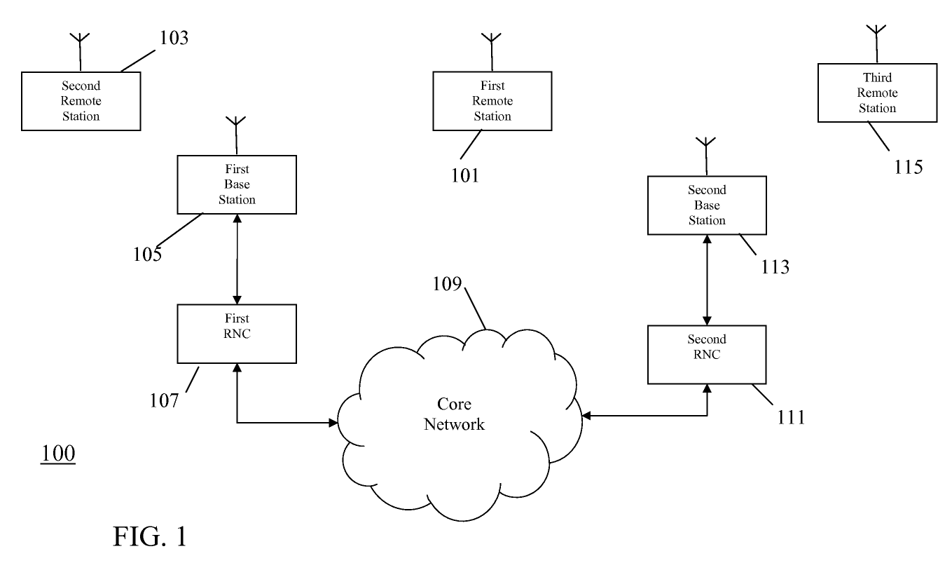

FIG. 1 illustrates an example of a cellular communication system 100 in accordance with some embodiments of the invention.

In a cellular communication system, a geographical region is divided into a number of cells each of which is served by a base station. The base stations are interconnected by a fixed network which can communicate data between the base stations. A remote station (e.g. a User Equipment (UE) or a mobile station) is served via a radio communication link by the base station of the cell within which the remote station is situated.

As a remote station moves, it may move from the coverage of one base station to the coverage of another, i.e. from one cell to another. As the remote station moves towards a base station, it enters a region of overlapping coverage of two base stations and within this overlap region it changes to be supported by the new base station. As the remote station moves further into the new cell, it continues to be supported by the new base station. This is known as a handover or handoff of a remote station between cells.

A typical cellular communication system extends coverage over typically an entire country and comprises hundreds or even thousands of cells supporting thousands or even millions of remote stations. Communication from a remote station to a base station is known as uplink, and communication from a base station to a remote station is known as downlink.

In the example of FIG. 1, a first remote station 101 and a second remote station 103 are in a first cell supported by a first base station 105.

The first base station 105 is coupled to a first RNC 107. An RNC performs many of the control functions related to the air interface including radio resource management and routing of data to and from appropriate base stations.

The first RNC 107 is coupled to a core network 109. A core network interconnects RNCs and is operable to route data between any two RNCs, thereby enabling a remote station in a cell to communicate with a remote station in any other cell. In addition, a core network comprises gateway functions for interconnecting to external networks such as the Public Switched Telephone Network (PSTN), thereby allowing remote stations to communicate with landline telephones and other communication terminals connected by a landline. Furthermore, the core network comprises much of the functionality required for managing a conventional cellular communication network including functionality for routing data, admission control, resource allocation, subscriber billing, remote station authentication etc.

The core network 109 is further coupled to a second RNC 111 which is coupled to a second base station 113. The second base station 113 supports a third remote station 115.

In the system of FIG. 1, the three remote stations 101, 103, 115 are involved in active HSUPA communication services. In the example, the second and third remote stations 103, 115 are supported by the first and second base station 105, 113 respectively in single handover configurations. Accordingly, the uplink data from the remote stations 103, 115 is scheduled by the first and second base station 105, 113 respectively. The first remote station 101 is currently supported in a soft handover configuration where the signal is received by both the first and second base station 105, 113 and combined in the fixed network. In the specific example where the base stations reside under different RNCs, selection combining will be used whereas soft combining may be used for cells of the same base station. In the example, the first remote station 101 is supported by the first base station 105 as the serving base station and thus the HSUPA uplink data is scheduled by a HSUPA scheduler of the first base station.

Thus, in the example, the second base station 113 schedules HSUPA uplink data for the third remote station 115 as well as other remote stations (not shown) supported by the third remote station 115 as a serving base station. However, significant parts of the available resource in the cell of the second base station 113 are used by remote stations such as the first remote station 101 for which the uplink data is scheduled by other base stations.

In the system of FIG. 1, the first base station 105 comprises functionality for implicitly signalling future intended resource allocations for the first remote station 101 to the second base station 113. Thus, a base station can be informed of future resource usage from remote stations that are scheduled by other base stations. The implicit signalling is achieved by the first base station 105 controlling the uplink data rate of the first remote station 101 such that it provides an indication of the future resource usage. The second base station 113 can detect the uplink data rate from the first remote station 101 and can from this infer the future resource usage. The second base station 113 can then take the resource usage of the first remote station 101 into account e.g. when scheduling HSUPA uplink data from other remote stations, such as the third remote station 115. The implicit signalling is achieved without any additional communication in the fixed network and specifically without requiring that explicit or specific messages are exchanged between the base stations 105,113. Furthermore, the approach is compatible with the Technical Specifications for UMTS and HSUPA and allows implementation without necessitating a change of these.

Thus, the approach enables cell i (that associated with the first base station 105) to indicate to cell k (that associated with the second base station) the amount of power that it will be consuming in a forthcoming period, so that cell k can make a better prediction of forthcoming demands on noise rise. The scheme enables this to be achieved by implicit signalling over the air interface and without resorting to sending the information explicitly over the network via the RNC.

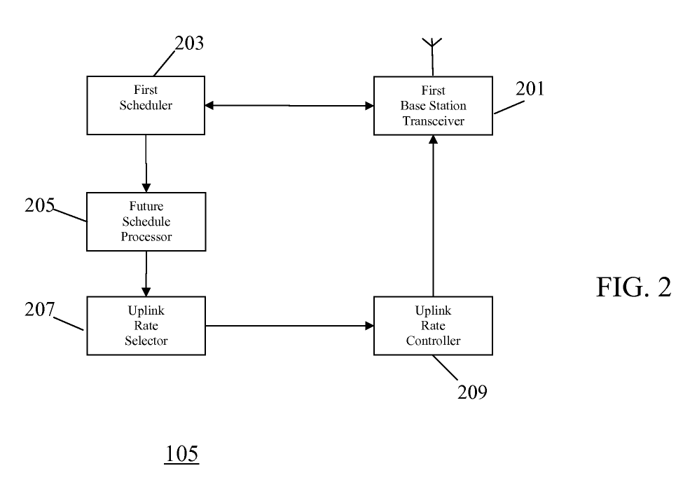

FIG. 2 illustrates elements of the first base station in more detail. The operation of the first base station 105 will be described with specific reference to the first and second remote stations 101,103 although it will be appreciated that the same principles may be applied to many or all of the remote stations supported by the first base station.

The first base station 105 comprises a first base station transceiver 201 which is operable to communicate with remote stations over the air interface of the UMTS cellular communication system. In particular, the first base station transceiver 201 is capable of supporting HSUPA communications for remote stations in both single handover and soft handover configurations.

The first base station transceiver 201 is coupled to a first scheduler 203 which is arranged to schedule HSUPA uplink communications for remote stations having the first base station as the serving base station and cell i as the serving cell. In the specific example, the first scheduler 203 schedules uplink HSUPA communications from the first and second remote stations 101, 103. Specifically, the first scheduler 203 schedules the uplink HSUPA data which is transmitted on the E-DCH of the remote stations.

The first scheduler 203 is coupled to a future schedule processor 205 which is arranged to determine a future scheduling resource allocation for the first remote station 101. Specifically, the first scheduler 203 provides the future schedule processor 205 with information of the scheduling for the future scheduling intervals. The future schedule processor 205 can then identify intended scheduling of uplink data from the first remote station 105.

The future schedule processor 205 is coupled to an uplink rate selector 207 which is arranged to select the uplink data rate that is to be used by the first remote station 101 in the following scheduling interval. Specifically the uplink data rate can be selected such that it provides an indication of the future scheduling resource allocation for the first remote station 101.

The uplink rate selector 207 is coupled to an uplink rate controller 209 which is further coupled to the first base station transceiver 201. The uplink rate controller 209 is arranged to set the value selected by the uplink rate selector 207. Specifically, the uplink rate controller 209 generates a suitable control message comprising a command to set the uplink rate to the selected value. This control message is fed to the first base station transceiver 201 and transmitted to the first remote station 101 over the air interface.

Thus, the first base station 105 comprises functionality for setting the uplink data rate from the first remote station 101 such that it is indicative of a future scheduling resource allocation for the first remote station 101. The uplink data rate can thus be set as an implicit signalling indication to the base stations involved in a soft handover of the first remote station 101. The setting of the data rate to indicate future resource allocation is in many embodiments limited to one or more scheduling intervals. For example, if the first remote station 101 is seeking to transmit a large amount of HSUPA uplink data, it may be scheduled with a high data rate of, say, 512 kb per second. However, in the first scheduling interval, the uplink data rate is not set to this value but is set to provide an indication of the future value. For example the uplink data rate may be set in accordance with the following table 1:

TABLE 1
Uplink Data Rate

| Initial Data Rate | Scheduled Data Rate | |
|---|---|---|
| 2 kbps | 32 | kbps |
| 4 kbps | 128 | kbps |
| 6 kbps | 512 | kbps |
| 8 kbps | 1024 | kbps |

This approach will provide that for the first scheduling interval in which data is received from the first remote station 101, the resource allocation is relatively low thereby ensuring that the impact on other cells is relatively low. At the same time, the selected data rate provides an indication of the future resource allocation for the first remote station 101 thereby allowing other base stations and schedulers to take the corresponding resource consumption in their cell into account. Following the scheduling interval(s) which is(are) used for implicit signalling, the first base station 105 can proceed to schedule data as required rather than to provide a signalling indication.

It will be appreciated that any suitable characteristic or parameter of the future scheduling resource allocation may be used. Specifically, as indicated above, the resource allocation may be considered in terms of the uplink scheduled data rate. As another example, the future scheduling resource allocation can be considered in terms of a future scheduling uplink power resource. For example, the data rate may be set to directly indicate the additional or absolute transmit power that is allowed to be used by the first remote station 101. As another example, the uplink data rate may be set to indicate a future uplink interference level of the first remote station 101 in the cell of the second base station 113. Specifically, the data rate can be set to reflect an increase in the noise level at the second base station 113 from communications scheduled by the first base station 105.

It will be appreciated that these parameters tend to be interdependent or equivalent. For example, the signalling data rate may be set to indicate the future data rate and the second base station 113 can use this information to calculate a corresponding uplink transmit power from the first remote station 101 and to estimate a noise rise at the second base station 113 corresponding to this uplink transmit power.

The setting of the uplink data rate for the first remote station 101 can be achieved by transmitting a message comprising an absolute uplink data rate and/or by transmitting a message comprising a relative uplink data rate indication to the first remote station 101. The data rate indication may be a direct indication of a permissible uplink data rate or may be an indirect indication such as an indication of the transmit power that may be used by the remote station 101. In the specific example of a HSUPA service in a UMTS cellular communication system, the first base station 105 can signal the uplink data rate by the use of explicit E-AGCH (Enhanced-Absolute Grant CHannel) signalling or can use signalling on the E-RGCH (Enhanced-Relative Grant CHannel). The use of an absolute grant process may provide a facilitated and/or more accurate control of the exact data rate whereas the use of relative signalling on the RGCH tends to be less resource demanding in terms of downlink power resource.

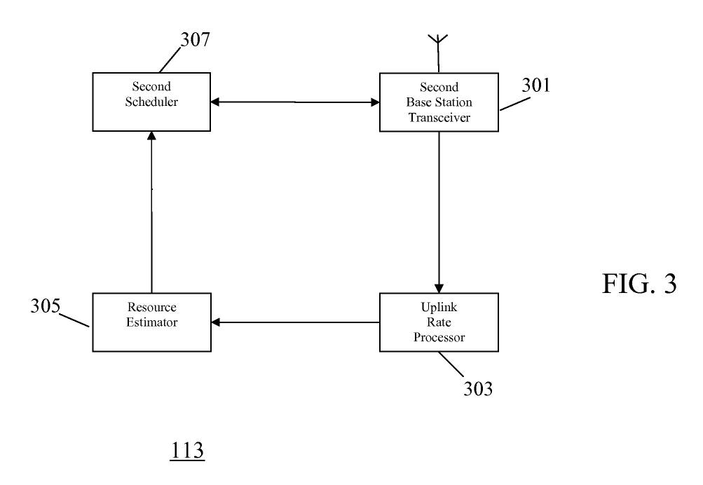

FIG. 3 illustrates elements of the second base station 113 in more detail.

The second base station 113 comprises a second base station transceiver 301 which is operable to communicate with remote stations over the air interface of the UMTS cellular communication system. In particular, the second base station transceiver 301 is capable of supporting HSUPA communications for remote stations in both single handover and soft handover configurations.

In the specific example, the second base station 113 supports the first remote station 101 in a soft handover configuration. The uplink data from the first remote station 101 is scheduled by the first base station 107 but is also received by the second base station transceiver 301 and combined with the signal received by the first base station (for example in the first RNC 107).

The second base station 113 furthermore comprises an uplink rate processor 303 which is coupled to a second base station transceiver 301 and which is arranged to determine the uplink data rate which is used by the first remote station 101 when transmitting the uplink data. The uplink data rate may for example be detected by blind detection (for example by trying to decode the uplink data for different assumed data rates and selecting the one that provides an appropriate output) or may be detected from uplink signalling from the first remote station 101.

The uplink rate processor 303 is coupled to a resource estimator 305 which is arranged to estimate a future resource usage for the first remote station 101 in the cell supported by the second base station 113.

As a specific example, the resource estimator 305 can receive information of the uplink data rate from the first remote station 101 in an initial scheduling interval. It can then determine the likely future scheduling data rate by a look-up in a look-up table corresponding to the one used by the first base station 107. Thus, in the specific example, if the initial data rate is 2 kbps, a subsequent uplink data rate of 32 kbps is assumed, if the initial data rate is 4 kbps, a subsequent uplink data rate of 128 kbps is assumed, if the initial data rate is 6 kbps, a subsequent uplink data rate of 512 kbps is assumed and if the initial data rate is 8 kbps, a subsequent uplink data rate of 1024 kbps is assumed.

The resource estimator 305 can then assume a corresponding noise rise associated with this data rate. This noise rise may for example be determined by measuring the received signal level in the initial interval and scaling this by the ratio between the subsequent uplink rate and the data rate of the initial interval.

The resource estimator 305 is coupled to a second scheduler 307 which is furthermore coupled to the second base station transceiver 301. The second scheduler 203 is arranged to schedule HSUPA uplink communications for remote stations having the second base station 113 as the serving base station and thus cell k as the serving cell. In the specific example, the second scheduler 307 schedules uplink HSUPA communications from the third remote station 115 to be transmitted on the E-DCH.

The scheduling by the second scheduler 307 is performed in response to the future resource usage estimated by the resource estimator 305. For example, the second scheduler 307 may subtract the resource estimated for the first remote station 101 from the total HSUPA resource allocation of the base station 113 before the scheduling of uplink data from the remote stations 115 served by the second base station 113 is performed. Specifically, the second scheduler 307 may subtract the estimated noise rise from a noise threshold that limits the scheduling of uplink data.

The described approach allows the second scheduler 307 to more accurately predict the noise rise attributable to channels which are under the control of other base stations and to thereby make more efficient usage of the uplink capacity/noise rise. In particular it enables the base stations to make shorter and probably higher rate allocations, thereby better exploiting upfade scheduling, better exploiting power that has been freed by other channels (i.e. better power packing), better priority handling etc.

In some embodiments, uplink data rate changes (such as an initialisation of a new uplink data communication or a change from one data rate to another) are restricted in accordance with a change criterion. For example, when a new communication is initiated, the maximum data rate in a first number of initial time intervals may be restricted to lower values. The second base station 113 may detect that a remote station is following such a criterion by detecting that the received data rates do not exceed the restriction limits. It may then use this information to infer that a future data rate will reach a certain level and may use this for scheduling data for subsequent time intervals.

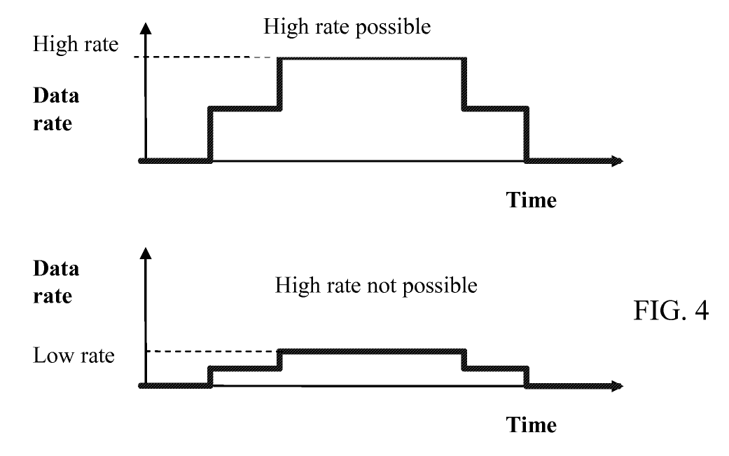

As a specific example of an approach where the uplink data rate is controlled to indicate future resource allocations is a system where a remote station which is being scheduled for the first time is allocated a low data rate in a first time interval, a higher rate in the following time and a higher rate still (e.g. the full scheduling rate) in a third time interval. In this way cell k gets warning in the first time interval that it's about to start receiving increasing amounts of signal from the first remote station 101, but because the signal in this time interval is sent at low power (low data rate) cell k can learn the information without having incurred the noise rise problems that would have occurred had the data immediately been sent at a high rate. Cell k can then use the information to start preparing for the arrival of the high power signal (e.g. by scheduling less data itself in a forthcoming period). Likewise, cell k could be informed of a forthcoming decrease in the power allocated to the first remote station 101 by a gradual ramping down of power/data rate. An example of such data rate ramping which can be used to indicate future resource usage is illustrated in FIG. 4.

A potential issue is that ramping up may not be supportable e.g. for a remote station at the cell edge. One solution is for the second scheduler 307 to allocate resource on the assumption that the first remote station 101 rate will ramp. Thus, if a ramping is detected in the first and second time interval, the scheduling for the third time interval is performed under the assumption that the data rate will be at the high level in this (and subsequent) intervals.

However, if the data rate does not increase in the third time interval, this can be detected by the second base station 113. The scheduler 307 can thus infer that the first remote station 101 is in a poor coverage spot and is unable to ramp and can then rectify its assumptions about future allocations for that remote station (e.g. it can assume that the data rate will remain constant). The only cost of such an approach is that the scheduler 307 will have been unnecessarily cautious in building its schedule for the third and subsequent time intervals, which could result in a slight loss of capacity

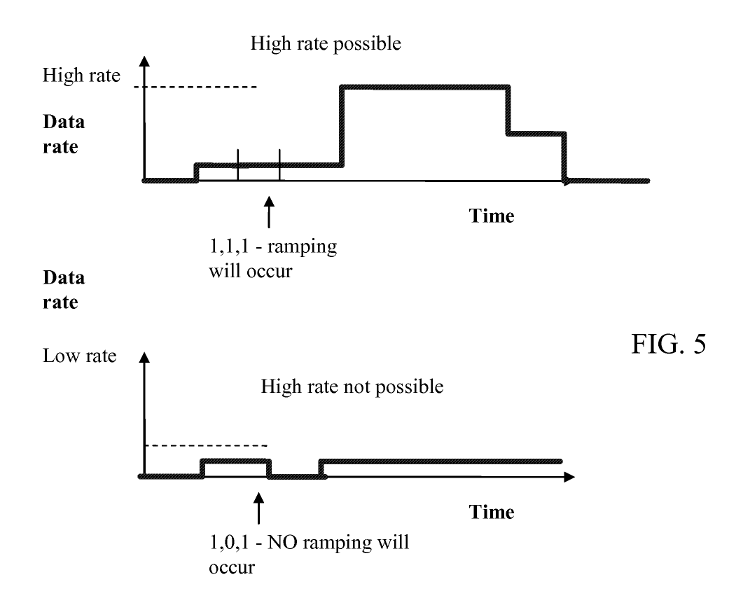

In another approach, the data rate can be set to follow a specific pattern in a plurality of time intervals where the pattern indicates a future resource usage (and specifically a future data rate). For example in the first few intervals, a binary pattern of ON/OFF scheduling could indicate whether ramping is going to occur or not. E.g. 1,0,1 can indicate that no ramping will occur, whilst a pattern of 1,1,1 can indicate that ramping will occur. Such an example is illustrated in FIG. 5.

It will be appreciated that the initial time interval(s) need not be an initial time interval for a new uplink communication session but may be any interval in which the data rate is used to signal a scheduling resource usage for a future time interval.

In HSUPA, a retransmission scheme is used for retransmission of uplink data that has not been correctly received. If the re-transmitted data needs to be transmitted at the same data rate as the first/preceding transmissions then this could potentially result in the shape of the envelope being disrupted, and this disruption could hence result in the information encoded by the envelope shape being corrupted. In order to avoid this, the initial time intervals which form the signalling information are arranged to fall within a duration which is shorter than the retransmission time for the retransmission scheme. For example, where the retransmission scheme uses a, say, 4 channel or 8 channel stop and wait, all the implicit signalling information is encoded in the first 4 (or 8) transmissions and before the re-transmissions have had a chance to be initiated.

The described approach assumes that the first remote station 101 has enough data buffered to generate the required envelope pattern. In order to ensure this, it is possible for the first scheduler 203 to make sure that enough data exists through the use of SI (Signalling Information) reporting which may indicate the uplink data buffer status of the first remote station 101.

HSUPA provides a mechanism for a non-serving cell to indicate to a remote station that the cell is overloaded and that the remote station should power down. This could potentially destroy the shape of the data rate envelope (and the information coded therein). One simple approach to overcome this issue is simply not to implement the feature by which a non-serving cell can control the data rate of a remote station or to simply accept that sometimes the scheme will not work so well during periods of (hopefully rare) overload.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A cellular communication system comprising:
a plurality of base stations for supporting soft handover communication of uplink data from at least a first remote station;
a first base station of the plurality of base stations comprising:
scheduling means for scheduling the uplink data from the first remote station,
setting means for setting an uplink data rate for the first remote station,
means for determining a future scheduling resource allocation for the first remote station, and
means for selecting the uplink data rate to indicate the future scheduling resource allocation; and
a second base station of the plurality of base stations comprising:
means for detecting the uplink data rate in response to receiving the uplink data from the first remote station, and
estimating means for estimating a future resource usage for the first remote station in a cell of the second base station in response to the uplink data rate.

2. The cellular communication system of claim 1 wherein the future scheduling resource allocation is one of the group of a future scheduling uplink data rate and a future scheduling uplink power resource.

3. The cellular communication system of claim 1 wherein the future resource usage is a future uplink interference level of the first remote station in the cell of the second base station.

4. The cellular communication system of claim 1 wherein the second base station further comprises second scheduling means for scheduling uplink data for at least a second remote station supported by the second base station in response to the future resource usage, and wherein the second scheduling means is arranged to modify the scheduling of uplink data for the at least second remote station in response to a detection that a resource usage of the first remote station in the cell of the second base station deviates from the future resource usage.

5. The cellular communication system of claim 1 wherein the first base station is arranged to select uplink data rates for a number of initial time intervals to indicate a future scheduling resource allocation in a future time interval.

6. The cellular communication system of claim 5 wherein the uplink data rates are selected to form a pattern indicative of the future scheduling resource allocation in the future time interval, wherein the pattern is a binary pattern of transmission or no transmission in the initial time intervals.

7. The cellular communication system of claim 5 wherein the uplink data rates of the number of initial time intervals are lower than the second uplink data rate.

8. The cellular communication system of claim 5 wherein the number of initial time intervals fall within a duration shorter than a retransmission time for a retransmission scheme for the first remote station.

9. The cellular communication system of claim 1 wherein the first base station is arranged to restrict uplink data rate changes in accordance with a change criterion and the estimating means is arranged to estimate the future resource usage in response to a detection that the uplink data rate matches the change criterion.

10. A method of signalling in a cellular communication system comprising a plurality of base stations supporting soft handover communication of uplink data from at least a first remote station; the method comprising:
at a first base station of the plurality of base stations performing the steps of:
scheduling the uplink data from the first remote station,
setting an uplink data rate for the first remote station,
determining a future scheduling resource allocation for the first remote station, and
selecting the uplink data rate to indicate the future scheduling resource allocation; and
at a second base station of the plurality of base stations performing the steps of:
detecting the uplink data rate in response to receiving the uplink data from the first remote station, and
estimating a future resource usage for the first remote station in a cell of the second base station in response to the uplink data rate.
